(19) United States
(12) Patent Application Publication
(10) Pub. No.: US 2021/0174447 A1
(43) Pub. Date: Jun. 10, 2021

(54) AUTOMATED SECURITIES RESOURCE ALLOCATION

(71) Applicant: Wells Fargo Bank, N.A., San Francisco, CA (US)

(72) Inventors: Melinda L. Li, San Francisco, CA (US); Aldo Anthony Ceccarelli, San Francisco, CA (US); A Erdem Cimen, San Francisco, CA (US); Rebecca S. MacDonald, San Francisco, CA (US); Jerry Wayne Johnson, San Francisco, CA (US)

(21) Appl. No.: 15/649,835

(22) Filed: Jul. 14, 2017

(51) Int. Cl. G06Q 40/06; G06Q 40/04

(52) U.S. Cl. CPC G06Q 40/06; G06Q 10/06; G06Q 40/04

(57) ABSTRACT

Systems and techniques for automated securities resource allocation are described herein. Data representing a resource allocation may be obtained. A data structure representing a resource allocation hierarchy may be generated for the resource allocation. A resource allocation access message may be transmitted to a plurality of entities. A set of resource allocation hierarchy requests may be received. Each resource allocation hierarchy request of the set of resource allocation hierarchy requests may correspond to an entity of the plurality of entities. An entity corresponding to a received resource allocation hierarchy request may be assigned to a node of the data structure. Resources may be transmitted to the entity based on the assignment of the entity to the node.

### TECHNICAL FIELD

Embodiments described herein generally relate to creation of data objects representing securities and, in some embodiments, more specifically to automated securities resource allocation.

### BACKGROUND

A marketable security (e.g., mutual fund, exchange traded fund, etc.) may have a variety of underlying assets (e.g., individual company stocks, bonds, etc.). A marketable security may be initially funded by collecting money which may then be used to buy the assets. There may be limited funds available for purchasing the assets. A fund manager may purchase assets (e.g., loans, interest bearing deposit accounts, stocks, bonds, etc.) of a variety of entities (e.g., corporations, financial institutions, etc.) using the funds.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 is a block diagram of an example of an environment and system for automated securities resource allocation, according to an embodiment.

FIG. 2 illustrates an example of a resource allocation hierarchy for automated securities resource allocation, according to an embodiment.

FIG. 3 illustrates an example of a process for automated securities resource allocation, according to an embodiment.

FIG. 4 illustrates an example of investor allocation for automated securities resource allocation, according to an embodiment.

FIG. 5 illustrates an example of a process for investor allocation for automated securities resource allocation, according to an embodiment.

FIG. 6 illustrates a flow diagram of an example method for automated securities resource allocation, according to an embodiment.

FIG. 7 is a block diagram illustrating an example of a machine upon which one or more embodiments may be implemented.

### DETAILED DESCRIPTION

A marketable security (e.g., mutual fund, exchange traded fund, etc.) may be initially funded (e.g., using cash, etc.) to purchase assets (e.g., stocks, bonds, etc.). The funding may include a fixed amount of money available to purchase the assets. For example, a funding institution may allocate an amount of money to buy assets. A fund manager may determine an asset mix for the marketable security and may purchase, using the allocation of money, a collection of assets based on the desired asset mix. The assets may be acquired through an exchange market dealing in the type of asset to be acquired. The purchased assets may be packaged as the underlying assets for the marketable security. The marketable security may then be submitted for listing on an exchange. For example, the marketable security may be submitted to a regulatory body for approval and listing on a stock exchange as an exchange-traded fund.

While the marketable security may include equity in an entity (e.g., stocks, etc.), the marketable security may include assets that may represent cash provided directly to an entity (e.g., corporation, financial institution, etc.) such as, for example, bank deposits, loans, etc. These types of assets may have fixed and/or variable returns (e.g., interest rates, yields, etc.) that may differ from entity to entity. Thus, entities may compete to for resources (e.g., cash, etc.) of the initial investment (e.g., initial fund allocation, etc.). In other words, the entities may compete to receive an allocation of cash in return for the payment based on the principal (e.g., outstanding cash balance, etc.) of the allocation (e.g., interest, yield, etc.) For example, multiple financial institutions may wish to obtain money deposits and may adjust a deposit yield in an effort to secure a deposit. The cash to be distributed in this manner may be considered a resource which may be allocated among entities based on a variety of parameters as discussed below.

The marketable security may have parameters for resource allocation such as for example, maximum (or minimum) allocations, term length, etc. For example, a retail investor in a marketable security may wish to take advantage of a pass-through benefit of an asset (e.g., insurance, etc.) and an asset allocation may be in an amount providing the pass-thorough benefit. In an example, insurance may be provided for deposits of $250,000 for each investor. There may be four retail investors each investing $250,000 and an asset allocation for a deposit to a financial institution may be limited to $1,000,000.

Entities may wish to obtain an allocation of less than the entire amount or resources available. Thus, requests for allocations from a plurality of entities may be evaluated and resources may be allocated to the entities based on the parameters for resource allocation. For example, there may $1,000,000 in resources available and the parameter may be that an entity may be allocated no more than $500,000. A first entity may request $250,000 at a yield of 1%, a second entity may request $1,000,000 at a yield of 0.5%, and a third entity may request $500,000 at a yield of 0.75%. The $1,000,000 of resources may be allocated as $250,000 to the first entity, $500,000 to the third entity, and $250,000 to the second entity.

Complexity of resource allocation may increase as additional parameters are added and as the number of resource requests increase. Likewise, as parameters change (e.g., a retail investor makes additional investment, additional retail investors make investments, a retail investor liquidates holding of the marketable security, etc.), the complexity of rebalancing the resource allocation increases. Thus, an automated resource allocator (e.g., resource broker, etc.) and an automated investment allocator (e.g., investor allocation broker, etc.) may allow for identification and allocation of resources and investments in complex and rapidly changing (e.g., due to the instantaneous nature of electronically traded securities, etc.) asset configurations.

The marketable security may be funded and a set of parameters (e.g., maximum deposit amounts, total investment, etc.) may be provided for allocation of the resources associated with the funding. The resource allocation may include all of the funds or some portion thereof. A resource allocation hierarchy may be generated using the resource allocation and each parameter. For example, a parameter of maximum allocation per entity of $250,000 may result in the creation of sub-resource branches in the resource allocation hierarchy with each an associated resource allocation of $250,000 with the totality of the resource allocations associated with each sub-allocation branch equaling the resource allocation.

In an example, the allocation hierarchy may include a number of branches each representing a sub-resource that may be allocated to an entity. For example, a resource allocation of $25,000,000 may be received with a parameter that a maximum resource allocation per entity is $12,500,000 by an automated resource broker which may generate two sub-resource branches each representing a sub-resource allocation of $12,500,000.

A hierarchy identifier may be transmitted (e.g., cryptographic key, invitation, URL, etc.) to a plurality of entities providing access to join the hierarchy. A set of resource requests may be received from the plurality of entities requesting resource allocations. For example, a first request may be received from entity A requesting $12,500,000 at an annual yield of 0.25%, a second request may be received from entity B requesting $10,000,000 at an annual yield of 0.3%, and a third request may be received from entity C requesting $2,500,000 at an annual yield of 0.35%.

Resource allocation nodes may be generated by the automated resource broker for each sub-resource branch of the resource allocation hierarchy based on the received resource requests. For example, a first resource allocation node representing a potential resource allocation of $2,500,000 may be generated and assigned to entity C, a second resource allocation node representing a potential allocation of $10,000,000 may be generated and assigned to entity B for a first sub-resource branch representing a sub-resource allocation of $12,500,000 and a third resource allocation node representing a potential resource allocation of $12,500,000 may be generated and assigned to entity A for a second sub-resource branch representing a sub-resource allocation of $12,500,000.

In an example, the received resource requests may be insufficient to fulfill each branch of the resource allocation hierarchy and the hierarchy identifier may be transmitted to a second plurality of entities. In such a case, additional received resource requests may be processed to generate additional resource allocation nodes. In an example, the nodes for each sub-resource branch may be discarded and regenerated upon receiving the additional resource requests. Thus, the resource request may be evaluated as a whole and may effectuate a more efficient allocation of resources (e.g., prioritizing better yields, preferred entities, etc.).

The resource allocation hierarchy may be used to transmit resources to each entity (e.g., using resource allocation node assignments for each entity, etc.). Upon transmitting the resources to the respective entities, a marketable security may be generated based on the resource allocations. The marketable security may include each resource allocated to the entities with the corresponding returns (e.g., yields, dividends, etc.) included in the request for resources from each entity. For example, the marketable security may include as assets the allocation of $2,500,000 to entity C at a yield of 0.35%, the allocation of $10,000,000 to entity B at a yield of 0.3%, and the allocation of $12,500,000 to entity A at a yield of 0.25%.

The marketable security may be automatically submitted for listing on a securities trading exchange (e.g., as an exchange-traded fund, mutual fund, etc.). For example, an exchange-traded fund may be generated and submitted to stock exchange for listing on the stock exchange. Investors may buy, sell, and trade the marketable security. Retail investors may invest in the marketable security by obtaining shares of the marketable security. The investors may wish to obtain pass-through benefits (e.g., insurance coverage, etc.) from underlying assets (e.g., resource allocations) of the marketable security. Thus, investors may be allocated to the resource allocations by assigning each investor to one or more of the resource allocation nodes in proportion to the investment amount of each investor a set of parameters for each investor (e.g., maximum investment allocation per entity, etc.).

In an example, an automated investor allocation broker may assign investors to each resource node based on a corresponding set of parameters (e.g., an investor may have a parameter of no more than $250,000 per resource allocation, etc.). Thus, the resource allocations may be attributed to the investors to effectuate adherence to the set of parameters specific to each investor. The attribution may allow for pass-through attribution of underlying assets to a specific investor. For example, each of investors A, B, C, D, and E may have a parameter of no more than $250,000 of allocated resources per entity and the $2,500,000 and investors A-E may be assigned to the first resource allocation node with an indication that $250,000 is attributed to each of investors A-E.

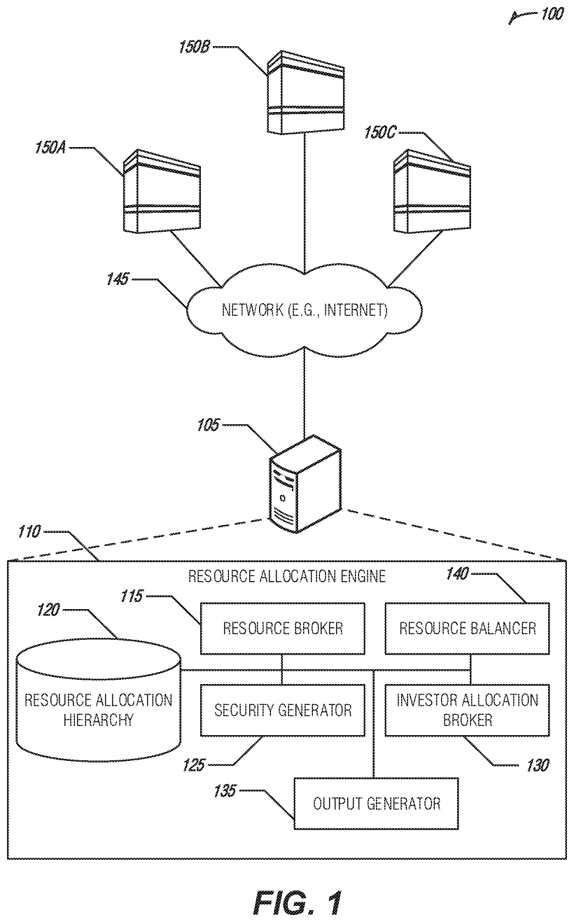

FIG. 1 is a block diagram of an example of an environment 100 and system 110 (e.g., resource allocation engine) for automated securities resource allocation, according to an embodiment. The environment 100 may include a computing device (e.g., server, cloud computing system, virtual server system, collection of servers, etc.) including the system 110. The computing device 105 may be communicatively coupled to a network 145 (e.g., the internet, wireless network, cellular network, etc.). Entity A 150A, entity B 150B, and entity C 150C (collectively referred to as entities 150) may be communicatively coupled to the network 145 (e.g., via a computing device, etc.). The system 110 may include a number of components such as a resource broker 115, a resource allocation hierarchy 120 (e.g., data structure, etc.), a security generator 125, an investor allocation broker 130, an output generator 135, and a resource balancer 140.

The resource broker 115 may allocate resources to the entities 150. The resource broker 115 may obtain a resource allocation (e.g., a quantity of funds, etc.). For example, a financial institution may designate an amount of money to the resource broker 115 for allocation. The resource broker 115 may include a graphical user interface including a variety of graphical user interface elements allowing interaction with the resource broker 115. For example, an employee of the financial institution may input a designated amount and a funding source and the resource broker 115 may use the designated amount as the resource allocation and may use the funding source to distribute funds to the entities 150. In another example, the resource broker 115 may include an application program interface (API) and inputs may be automatically received via the API (e.g., from another computing system, etc.).

The resource broker 115 may generate the resource allocation hierarchy 120. The resource allocation hierarchy 120 may include a data structure. In an example, the resource allocation hierarchy 120 may include a variety of branches and nodes generated by the resource broker 115. In an example, the resource broker 115 may generate one or more sub-resource allocation branches in the resource allocation hierarchy 120. A sub-resource allocation branch may represent a portion of the resource allocation. The resource broker 115 may generate the branches based on hierarchy creation parameters. For example, the sub-resource allocation branches may be generated based on a maximum resource allocation that may be made to one of the entities 150. In an example, the resource broker 115 may generate one or more resource allocation nodes for each sub-resource allocation branch. A resource allocation node may represent a block of resources that may be allocated to of the entities 150.

The output generator 135 may generate output for transmission and/or display. The resource broker 115 may work in conjunction with the output generator 135 to generate and transmit a resource allocation hierarchy identifier (e.g., a URL, cryptographic key, etc.) to the entities 150. For example, an email with a link to a webpage including the resource allocation hierarchy 120 may be transmitted to the entities 150. The entities 150 may be provided with security credentials (e.g., username, password, security certificate, etc.) to use when accessing the resource allocation hierarchy 120. The entities 150 may transmit a resource allocation hierarchy request to the resource broker 115. In an example, a set of resource allocation hierarchy requests may be received by the resource broker 115. Each resource allocation hierarchy request of the set of resource allocation hierarchy requests may correspond to one of the entities 150.

For example, a sub-allocation branch of the resource allocation hierarchy 120 may represent an allocation of $250,000 and entity A 150A may transmit a resource allocation hierarchy request that requests a resource allocation of $250,000 corresponding with the sub-resource allocation branch. In another example, entity A 150A may transmit a resource allocation hierarchy request that requests $125,000 of the $250,000 corresponding with the sub-resource allocation branch and entity B 150B may transmit a resource allocation hierarchy request that requests $250,000 corresponding with the sub-resource allocation branch.

The resource broker 115 may arrange the entities 150 corresponding to each of the received resource allocation hierarchy requests into the resource allocation hierarchy 120. The resource allocation hierarchy requests may include a variety of resource request parameters such as, for example, a desired allocation amount, a length of time for the resource allocation, a return (e.g., yield, interest, etc.) for the resource allocation, etc. The resource broker 115 may utilize the resource request parameters in arranging the entities 150 into the resource allocation hierarchy 120. The resource broker 115 may use a sorting algorithm to determine the arrangement of the entities 150 in the resource allocation hierarchy 120. In an example, the resource broker 115 may generate resource allocation nodes for the sub-resource allocation branch and may assign entities to the resource allocation nodes.

For example, a first resource allocation hierarchy request may be received from entity A 150A including a desired allocation of $125,000 at a yield of 0.30% per year and a second resource allocation hierarchy request may be received from entity B 150B including a desired resource allocation of $250,000 at a yield of 0.25% per year. The resource broker 115 may generate a first resource allocation node for the sub-resource allocation branch representing $125,000 of the total $250,000 represented by the sub-resource allocation branch. The resource broker 115 may assign entity A 150A to the first resource allocation node based on the yield of the resource allocation hierarchy request for entity A 150A being higher than the yield of the resource allocation hierarchy request for entity B 150B. The resource broker 115 may generate a second resource allocation node for the sub-resource allocation branch representing $125,000 of the total $250,000 represented by the sub-resource allocation branch and may assign entity B 150B to the second resource allocation node. The resource broker 115 may generate a third resource allocation node for another sub-resource allocation branch (if one exists) and may assign entity B 150B to the third resource allocation node representing the remaining $125,000 included in the resource allocation hierarchy request for entity B 150B. Thus, the resource broker 115 may generate additional resource allocations until the resources associated with each sub-resource allocation branch has been allocated.

The resource broker 115 may transmit resources to the entities 150 based on the arrangement of the resource allocation hierarchy 120. In an example, the resource broker 115 may transmit resources corresponding to each resource allocation node to an entity assigned to a respective resource allocation node(s). For example, $125,000 may be transmitted to entity A 150A based on entity A 105A being assign to the first resource allocation node and $125,000 may be transmitted to entity B 150B based on entity B 150B being assigned to the second resource allocation node.

The security generator 125 may generate a marketable security based on the assignment of the entities 150 to the resource allocation nodes of the resource allocation hierarchy 120. For example, the entities 150 may be finical institutions and an exchange-trade fund may be generated on resource allocations to the entities 150 as deposits into accounts created at each of the financial institutions. The security generator 125 may present the marketable security to an exchange (e.g., a stock exchange, etc.). In some cases, the marketable security may undergo regulatory review. In such cases, the security generator 125 may present the marketable security to a regulatory body for review. Upon receiving approval from the regulatory body, the security generator 125 may present the marketable security to the exchange.

The investor allocation broker 130 may allocate investors to resource allocation nodes assigned to the entities 150. The investor allocation broker 130 may identify an investor in the marketable security. For example, the investor allocation broker 130 may access a shareholder database or other record of holders of the marketable security and may identify the investor based on for example, changes in the records. The investor allocation broker 130 may obtain an investment parameter for the investor. The investor may have a variety of investor parameters such as, for example, amount of investment, maximum investment per entity, etc. The investor allocation broker 130 may assign the investor to a resource allocation node based on the investment parameter.

In an example, the investment parameter may be a maximum investment parameter indicating a maximum investment the investor wishes to invest per entity. The investor allocation broker 130 may generate an investor allocation sub-node for the resource allocation node representing a portion of the resources transmitted to an entity assigned to the resource allocation node. The portion may be equal to the maximum investment parameter. The investor may be assigned to the investor allocation sub-node. For example, John Que may invest $500,000 in the marketable security and may have a maximum investment parameter that indicates that no more than $250,000 of the investment may be allocated to resource allocations to an entity. The investor allocation broker 130 may generate a first investor allocation sub-node assigned to the first resource allocation assigned to entity A 150A representing $125,000, a second investor allocation sub-node assigned to the second resource allocation assigned to entity B 150B representing $125,000, and a third investor allocation sub-node assigned to a fifth resource allocation assigned to entity C 150C representing $250,000. Thus, the entities 150 and the investors are linked through mutual assignment to resource allocation nodes. Therefore, investor/entity relationships may be identified to provide pass-through benefits to individual investors of the marketable security.

Resource allocations may change over time for a variety of reasons. For example, additional funding to satisfy additional investors, resource allocation terms may expire, insolvency of one of the entities, etc. In some cases, the resource broker 115 may maintain a reserve resource allocation pool. In an example, the resource broker 115 may generate a sub-resource allocation branch for the reserve resource allocation pool. For example, the resource broker 115 may obtain a resource allocation of $1,000,000 and may generate a sub-resource branch representing a $250,000 resource allocation to the reserve resource allocation pool. Resource allocations may be returned to the resource broker 115 (e.g., when a resource allocation term expires, etc.).

The resource balancer 140 may balance resource allocations by modifying the resource allocation hierarchy 120. For example, a resource allocation may be returned by an entity. The resource balancer 140 may generate a temporary resource allocation node for the returned resource allocation and may transfer any investor allocation sub-nodes to the temporary resource allocation node. The resource balancer may work with the resource broker 115 to transmit a resource allocation hierarchy identifier to the entities 150 including the temporary resource allocation node. Additional resource allocation nodes may be generated based on received resource allocation hierarchy requests.

In another example, a subsequent resource allocation may be obtained. The resource broker 115 may generate additional sub-allocation branches and corresponding nodes as described above. The resource balancer 140 may reassign investors to resource allocation nodes based on the investment parameters of the investors. In some examples, an investor may increase or decrease investment in the marketable security and the resource balancer 140 may update resource node assignments for the investor based on the current investment amount and the investment parameters for the investor.

The present subject matter may be implemented in various configurations. For example, resource broker 115, the resource allocation hierarchy 120, the security generator 125, the investor allocation broker 130, the output generator 135, and the resource balancer 140 may be implemented in different (or the same) computing systems (e.g., a single server, a collection of servers, a cloud-based computing platform, etc.).

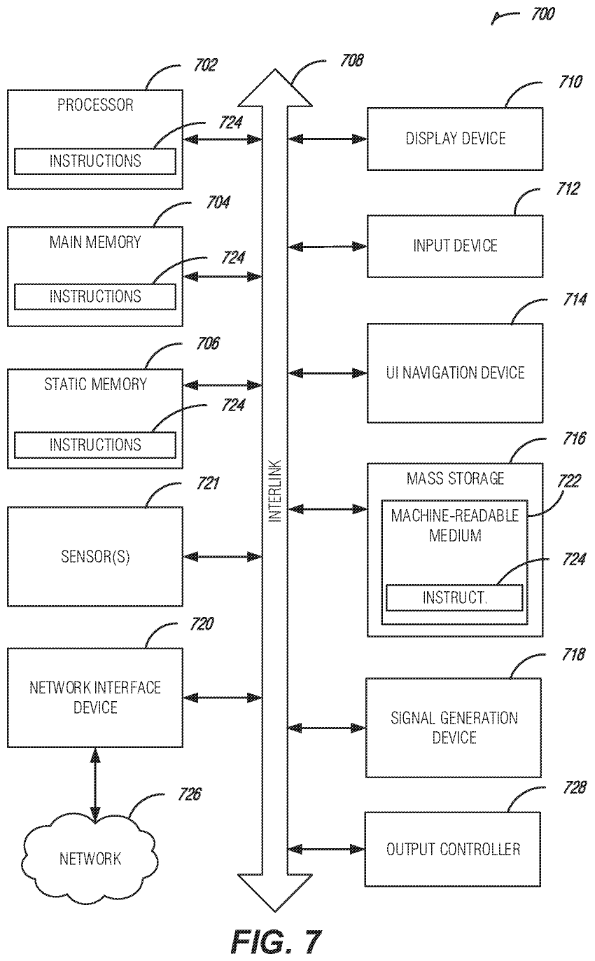

The resource broker 115, the resource allocation hierarchy 120, the security generator 125, the investor allocation broker 130, the output generator 135, and the resource balancer 140 may comprise one or more processors (e.g., hardware processor 702 described in FIG. 7, etc.) that execute software instructions, such as those used to define a software or computer program, stored in a computer-readable storage medium such as a memory device (e.g., a main memory 704 and a static memory 706 as described in FIG. 7, a Flash memory, random access memory (RAM), or any other type of volatile or non-volatile memory that stores instructions), or a storage device (e.g., a disk drive, or an optical drive). Alternatively, The resource broker 115, the resource allocation hierarchy 120, the security generator 125, the investor allocation broker 130, the output generator 135, and the resource balancer 140 may comprise dedicated hardware, such as one or more integrated circuits, one or more Application Specific Integrated Circuits (ASICs), one or more Application Specific Special Processors (ASSPs), one or more Field Programmable Gate Arrays (FPGAs), or any combination of the foregoing examples of dedicated hardware, for performing the techniques described in this disclosure.

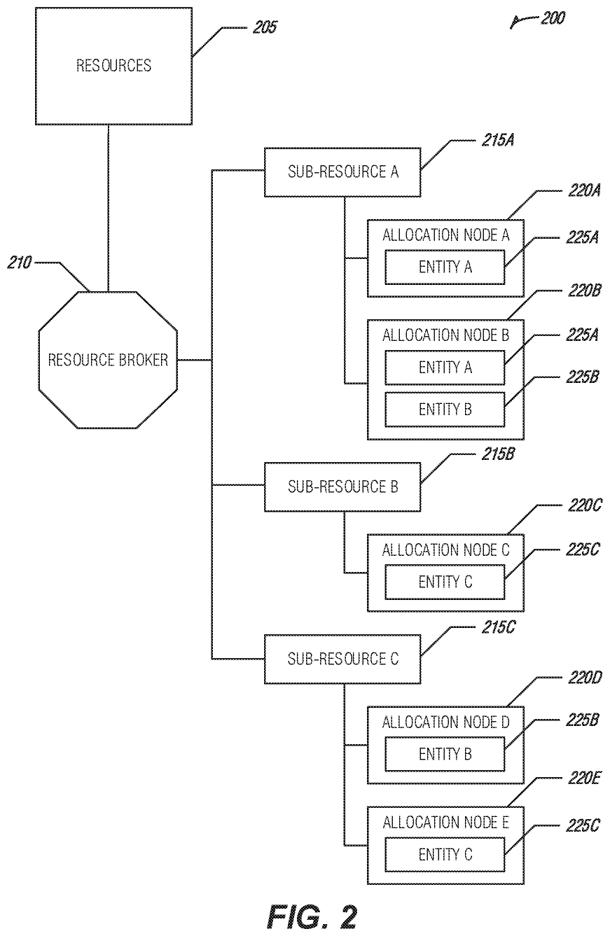

FIG. 2 illustrates an example of a resource allocation hierarchy 200 for automated securities resource allocation, according to an embodiment. The resource allocation hierarchy 200 may provide features as described in FIG. 2. The resource allocation hierarchy 200 may be generated by a resource broker 210 based on a resource allocation 205 obtained by the resource broker 210. The resource allocation hierarchy may include a sub-resource allocation branch A 215A, a sub-resource allocation branch B 215B, and a sub-resource allocation branch C 215C (collectively the sub-resource allocation branches 215). The sub-resource allocation branches 215 may include a resource allocation node A 220A, a resource allocation node B 220B, a resource allocation node C 220C, a resource allocation node D 220D, and a resource allocation node E 220E, (collectively the resource allocation nodes 220). The resource nodes 220 may include assignments to an entity A 225A, an entity B 225B, and an entity C 225C (collectively the entities 225).

As described in FIG. 1, the resource broker may generate the sub-resource branches 215 based on the resource allocation 205 and a set of resource allocation parameters. For example, the sub-resource branches may be generated based on an allocation parameter indicating a maximum resource allocation for one of the entities 225. The resource broker 210 may transmit a resource allocation hierarchy identifier to the entities 225 and the entities 225 may transmit a resource allocation hierarchy request including resource request parameters. The resource broker 210 may generate the resource allocation nodes 220 based on the received resource allocation hierarchy requests and included resource request parameters. The entities 225 may be assigned to the resource allocation nodes 220. The resource broker 210 may transmit resources to the entities 225 based on the respective assignments of the entities 225 in the resource allocation hierarchy 200.

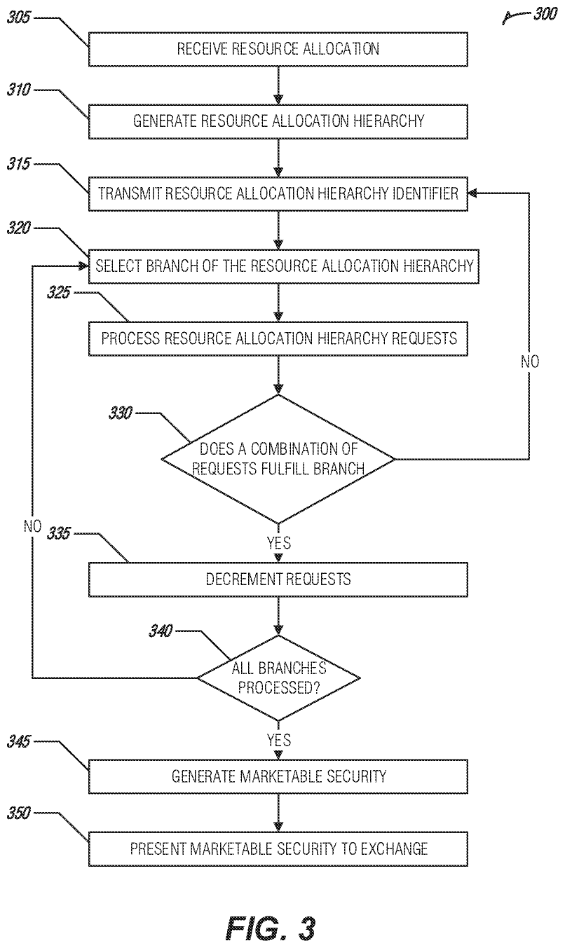

FIG. 3 illustrates an example of a process 300 for automated securities resource allocation, according to an embodiment. The process 300 may provide features as described in FIGS. 1 and 2. A resource allocation may be received (e.g., from a financial institution, brokerage house, etc.) (e.g., at operation 305). A resource allocation hierarchy may be generated by a resource broker (e.g., by the resource broker 115 as described in FIG. 1) (e.g., at operation 310). A resource allocation hierarchy identifier may be transmitted (e.g., by the resource generator 115 as described in FIG. 1) to a plurality of entities (e.g., financial institutions, corporations, etc.) (e.g., at operation 315). A branch (e.g., one of the sub-resource allocation branches 215 as described in FIG. 2, etc.) of the resource allocation hierarchy may be selected (e.g., at operation 320). Received resource allocation hierarchy request may be processed to generate resource allocation nodes for the selected branch of the resource allocation hierarchy (e.g., at operations 325).

It may be determined if a combination of resource allocation hierarchy requests fulfills the selected branch of the resource allocation hierarchy (e.g., at decision 330). If the selected branch of the resource allocation hierarchy has not been fulfilled, the resource allocation hierarchy identifier may be transmitted to additional entities (e.g., at operation 315). For example, the resource broker may maintain a tiered set of entities and if a first tier of entities fails to transmit resource allocation hierarchy requests sufficient to fulfill a tier the identifier may be transmitted to the next tier of entities, etc.

If the selected branch of the resource allocation hierarchy has been fulfilled, the resource allocation hierarchy request may be decremented (e.g., at operation 335). In other words, an amount requested in a resource allocation hierarchy request for an entity may be reduced by the amount assigned to a resource allocations node of a sub-resource allocation branch. It may be determined if all of the branches of the resource allocation hierarchy have been processed (e.g., at decision 340). If there are branches of the resource allocation hierarchy that have not been processed, another branch of the resource allocation hierarchy may be selected (e.g., at operation 320) and processed as described above.

If all of the branches of the resource allocation hierarchy have been processed (e.g., as determined at decision 340), a marketable security may be generated (e.g., at operation 345). For example, an exchange-traded fund may be generated with assets consisting of the resource allocations made to each entity. The marketable security may be presented to an exchange (e.g., at operation 350). For example, the marketable security may be listed on a stock exchange.

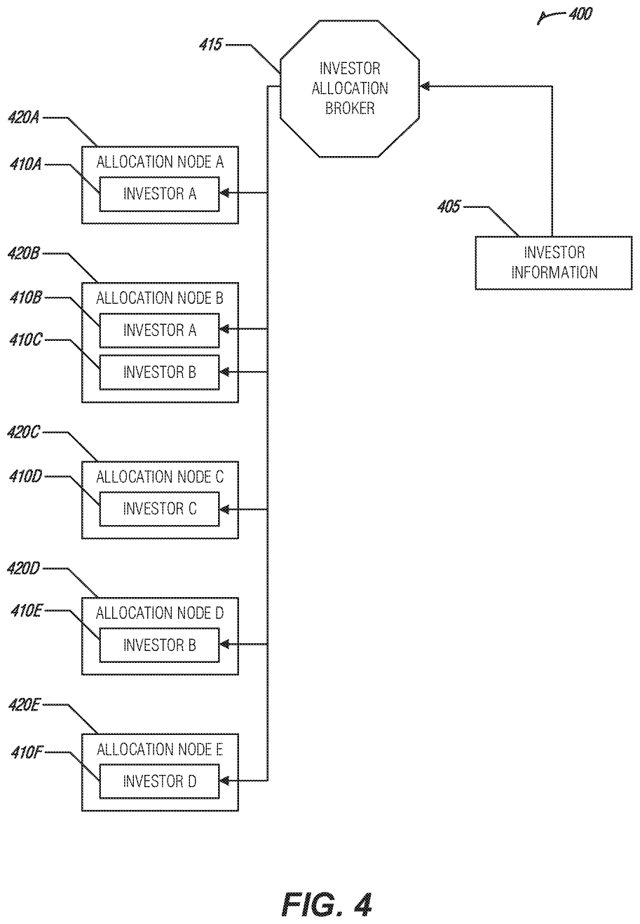

FIG. 4 illustrates an example of investor allocation 400 for automated securities resource allocation, according to an embodiment. The investor allocation 400 may provide features as described in FIG. 1. The investor allocation 400 may include investor information 405 and an investor allocation broker 415. The investor allocation broker 415 may obtain the investor information 405. The investor information 405 may include an identity of an investor and investment parameters (e.g., investment amount, maximum amount per entity, etc.).

A resource allocation node A 420A, a resource allocation node B 420B, a resource allocation node C 420C, a resource allocation node D 420D, and a resource allocation node E 420E (collectively the resource allocation nodes 420) may have been generated by a resource broker (e.g., as described in FIG. 1). The investment allocation broker 415 may generate investor allocation sub-nodes 410A, 410B, 410C, 410D, 410E, and 410F (collectively the investor allocation sub-nodes) based on the investment parameters and the resource allocation nodes 420.

For example, investor A may have invested $500,000 and may have an investment parameter indicating that a maximum allocation per entity be $250,000. Resource allocation node A 420A may be a resource allocation to a first entity representing $250,000 and investor allocation sub-node 410A may be generated and assigned to resource allocation node A 420A representing $250,000 of the total $500,000 investment of investor A. Resource allocation node B 420B may be a resource allocation to a second entity representing $500,000 and investor allocation sub-node 410B may be generated and assigned to resource allocation node B 420B representing the remaining $250,000 of the total $500,000 investment of investor A. The generation and assignment of additional investor allocation sub-nodes may continue until investments of each investor have been processed.

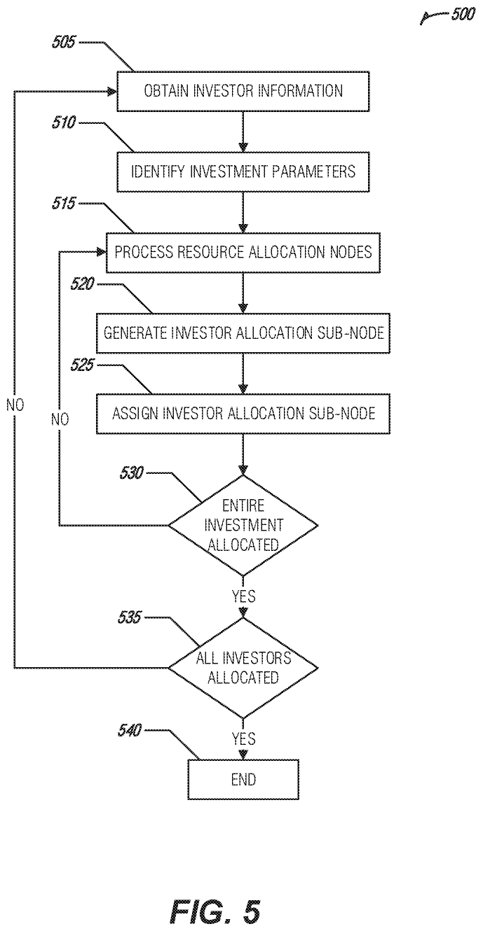

FIG. 5 illustrates an example of a process 500 for investor allocation for automated securities resource allocation, according to an embodiment. The process 500 may provide features as described in FIGS. 1 and 4. Investor information may be obtained by an investor allocation broker (e.g., the investment allocation broker 130 as described in FIG. 1) (e.g., at operation 505). A investment parameters may be identified (e.g., at operation 510) for each of the investors such as, for example, an amount invested, a maximum investment allocation per entity, etc. Resource allocation nodes generated by a resource broker (e.g., resource broker 115 as described in FIG. 1) may be processed to identify resource allocation nodes for inventor assignment (e.g., at operation 515).

An investor sub-allocation node may be generated based for a suitable resource allocation node based on the investor parameters (e.g., at operation 520). The generated investor allocation sub-node may be assigned to a suitable resource allocation node (e.g., at operation 525). If it is determined that a total investment of the investor has not been allocated (e.g., at decision 530), additional resource allocation nodes may be processed (e.g., at operation 515) until the entirety of the investment of the investor has been allocated. If it is determined that a total investment of the investor has been allocated (e.g., at decision 530), it may be determined whether investments by all investors have been allocated (e.g., at decision 535). If there are remaining investors with unallocated investments (e.g., as determined at operation 535), additional investor information may be processed (e.g., at operation 505). If all investments have been allocated, the process 500 may end (e.g., at operation 540).

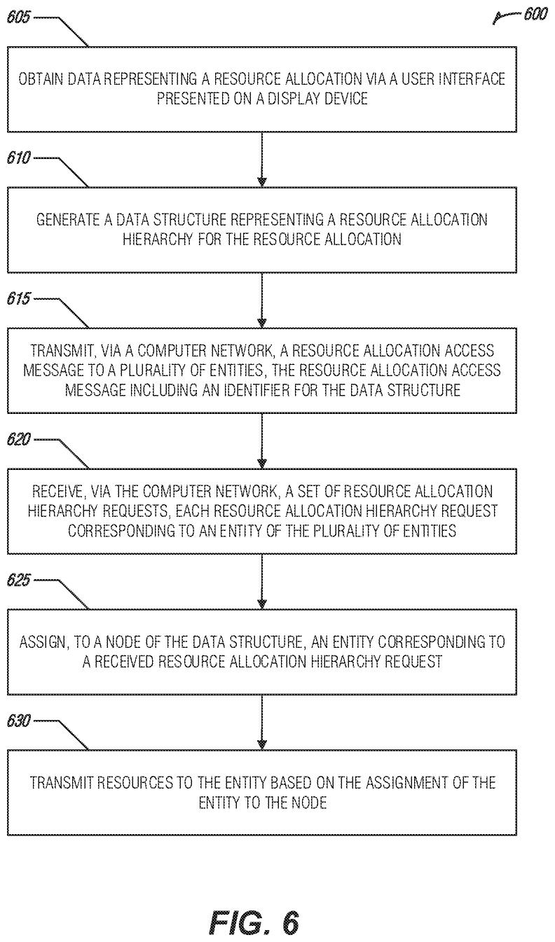

FIG. 6 illustrates a flow diagram of an example method 600 for automated securities resource allocation, according to an embodiment. The method 600 may provide features as described in FIGS. 1-5.

Data representing a resource allocation may be obtained (e.g., at operation 605), for example, via a user interface presented on a display device. A data structure representing aresource allocation hierarchy (e.g., as described in FIG. 2, etc.) may be generated (e.g., by the resource broker 115 as described in FIG. 1) for the resource allocation (e.g., at operation 610). In an example, a sub-resource allocation branch may be generated for the data structure. In an example, a resource allocation node may be generated for the sub-resource allocation branch. A resource allocation access message may be transmitted to a plurality of entities, for example, via a computer network. The resource allocation access message may include an identifier for the data structure (e.g., at operation 615). A set of resource allocation hierarchy requests may be received (e.g., at operation 620), for example, via the computer network. Each resource allocation hierarchy request may correspond to an entity of the plurality of entities. In an example, each hierarchy request of the set of hierarchy requests may include a request parameter.

An entity corresponding to a received resource allocation hierarchy request may be assigned to a node of the data structure (e.g., at operation 625). In an example, the node may be the resource allocation node. In an example, the entity may be assigned to the data structure using the request parameter. Resources may be transmitted to the entity based on the assignment of the entity to the node (e.g., at operation 630).

In an example, a marketable security may be automatically generated using the data structure and the marketable security may be presented to an exchange. In an example, an investor of the marketable security may be identified. An investment parameter may be obtained for the investor and the investor may be assigned to the resource allocation node based on the investment parameter.

FIG. 7 illustrates a block diagram of an example machine 700 upon which any one or more of the techniques (e.g., methodologies) discussed herein may perform. In alternative embodiments, the machine 700 may operate as a standalone device or may be connected (e.g., networked) to other machines. In a networked deployment, the machine 700 may operate in the capacity of a server machine, a client machine, or both in server-client network environments. In an example, the machine 700 may act as a peer machine in peer-to-peer (P2P) (or other distributed) network environment. The machine 700 may be a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate by, logic or a number of components, or mechanisms. Circuit sets are a collection of circuits implemented in tangible entities that include hardware (e.g., simple circuits, gates, logic, etc.). Circuit set membership may be flexible over time and underlying hardware variability. Circuit sets include members that may, alone or in combination, perform specified operations when operating. In an example, hardware of the circuit set may be immutably designed to carry out a specific operation (e.g., hardwired). In an example, the hardware of the circuit set may include variably connected physical components (e.g., execution units, transistors, simple circuits, etc.) including a computer readable medium physically modified (e.g., magnetically, electrically, moveable placement of invariant massed particles, etc.) to encode instructions of the specific operation. In connecting the physical components, the underlying electrical properties of a hardware constituent are changed, for example, from an insulator to a conductor or vice versa. The instructions enable embedded hardware (e.g., the execution units or a loading mechanism) to create members of the circuit set in hardware via the variable connections to carry out portions of the specific operation when in operation. Accordingly, the computer readable medium is communicatively coupled to the other components of the circuit set member when the device is operating. In an example, any of the physical components may be used in more than one member of more than one circuit set. For example, under operation, execution units may be used in a first circuit of a first circuit set at one point in time and reused by a second circuit in the first circuit set, or by a third circuit in a second circuit set at a different time.

Machine (e.g., computer system) 700 may include a hardware processor 702 (e.g., a central processing unit (CPU), a graphics processing unit (GPU), a hardware processor core, or any combination thereof), a main memory 704 and a static memory 706, some or all of which may communicate with each other via an interlink (e.g., bus) 708. The machine 700 may further include a display unit 710, an alphanumeric input device 712 (e.g., a keyboard), and a user interface (UI) navigation device 714 (e.g., a mouse). In an example, the display unit 710, input device 712 and UI navigation device 714 may be a touch screen display. The machine 700 may additionally include a storage device (e.g., drive unit) 716, a signal generation device 718 (e.g., a speaker), a network interface device 720, and one or more sensors 721, such as a global positioning system (GPS) sensor, compass, accelerometer, or other sensor. The machine 700 may include an output controller 728, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 716 may include a machine readable medium 722 on which is stored one or more sets of data structures or instructions 724 (e.g., software) embodying or utilized by any one or more of the techniques or functions described herein. The instructions 724 may also reside, completely or at least partially, within the main memory 704, within static memory 706, or within the hardware processor 702 during execution thereof by the machine 700. In an example, one or any combination of the hardware processor 702, the main memory 704, the static memory 706, or the storage device 716 may constitute machine readable media.

While the machine readable medium 722 is illustrated as a single medium, the term “machine readable medium” may include a single medium or multiple media (e.g., a centralized or distributed database, and/or associated caches and servers) configured to store the one or more instructions 724.

The term “machine readable medium” may include any medium that is capable of storing, encoding, or carrying instructions for execution by the machine 700 and that cause the machine 700 to perform any one or more of the techniques of the present disclosure, or that is capable of storing, encoding or carrying data structures used by or associated with such instructions. Non-limiting machine readable medium examples may include solid-state memories, and optical and magnetic media. In an example, a massed machine readable medium comprises a machine readable medium with a plurality of particles having invariant (e.g., rest) mass. Accordingly, massed machine-readable media are not transitory propagating signals. Specific examples of massed machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 724 may further be transmitted or received over a communications network 726 using a transmission medium via the network interface device 720 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi@, IEEE 802.16 family of standards known as WiMax®), IEEE 802.15.4 family of standards, peer-to-peer (P2P) networks, among others. In an example, the network interface device 720 may include one or more physical jacks (e.g., Ethernet, coaxial, or phone jacks) or one or more antennas to connect to the communications network 726. In an example, the network interface device 720 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 700, and includes digital or analog communications signals or other intangible medium to facilitate communication of such software.

### ADDITIONAL NOTES

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments may be used, such as by one of ordinary skill in the art upon reviewing the above description. The Abstract is to allow the reader to quickly ascertain the nature of the technical disclosure and is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment. The scope of the embodiments should be determined with reference to the appended claims, along with the full scope of equivalents to which such claims are entitled.

1. A system for facilitating automatic resource allocation, the system comprising:
at least one processor; and
at least one machine readable medium including instructions that, when executed by the at least one processor, cause the at least one processor to perform operations including:
obtaining, via a user interface presented on a display device, data representing a resource allocation, the resource allocation having one or more resource-allocation parameters;
generating a resource-allocation-hierarchy data structure that represents a resource allocation hierarchy for the resource allocation, the resource-allocation-hierarchy data structure including a plurality of sub-resource allocation branches based on the resource-allocation parameters;
transmitting, via a computer network, a resource allocation access message to a plurality of entities, the resource allocation access message including a hierarchy identifier for the resource-allocation-hierarchy data structure, the hierarchy identifier providing access by each of the entities in the plurality of entities to the resource-allocation-hierarchy data structure, each of the entities having been provided with security credentials to use when accessing the resource-allocation-hierarchy data structure;
receiving, via the computer network, a set of resource allocation hierarchy requests, each resource allocation hierarchy request (i) corresponding to an entity of the plurality of entities and (ii) including a set of request parameters;
based on a comparison between the resource-allocation parameters of the resource allocation and the request parameters of the resource allocation hierarchy requests, generating at least one resource allocation node for each sub-resource allocation branch, and assigning one or more of the entities in the plurality of entities to each of the resource allocation nodes across the plurality of sub-resource allocation branches;
transmitting resources to each entity that has been assigned to at least one resource allocation node;
automatically generating a marketable security using the data structure; and
presenting the marketable security to an exchange.

2-5. (canceled)

6. The system of claim 1, the operations further comprising:
identifying an investor in the marketable security;
obtaining an investment parameter for the investor; and
assigning the investor to one of the resource allocation nodes based on the investment parameter.

7. The system of claim 6, wherein:
the investment parameter is a maximum investment parameter; and
assigning the investor to one of the resource allocation nodes includes:
generating an investor allocation sub-node for the resource allocation node, the investor allocation sub-node representing a portion of the resources transmitted to the entity assigned to the resource allocation node, the portion being equal to the maximum investment parameter; and
assigning the investor to the investor allocation sub-node.

8. At least one machine readable medium including instructions for facilitating automatic resource allocation that, when executed by a machine, cause the machine to perform operations comprising:
obtaining, via a user interface presented on a display device, data representing a resource allocation, the resource allocation having one or more resource-allocation parameters;
generating a resource-allocation-hierarchy data structure that represents a resource allocation hierarchy for the resource allocation, the resource-allocation-hierarchy data structure including a plurality of sub-resource allocation branches based on the resource-allocation parameters;
transmitting, via a computer network, a resource allocation access message to a plurality of entities, the resource allocation access message including a hierarchy identifier for the resource-allocation-hierarchy data structure, the hierarchy identifier providing access by each of the entities in the plurality of entities to the resource-allocation-hierarchy data structure, each of the entities having been provided with security credentials to use when accessing the resource-allocation-hierarchy data structure;
receiving, via the computer network, a set of resource allocation hierarchy requests, each resource allocation hierarchy request (i) corresponding to an entity of the plurality of entities and (ii) including a set of request parameters;
based on a comparison between the resource-allocation parameters of the resource allocation and the request parameters of the resource allocation hierarchy requests, generating at least one resource allocation node for each sub-resource allocation branch, and assigning one or more of the entities in the plurality of entities to each of the resource allocation nodes across the plurality of sub-resource allocation branches;
transmitting resources to each entity that has been assigned to at least one resource allocation node;
automatically generating a marketable security using the data structure; and
presenting the marketable security to an exchange.

9-12. (canceled)

13. The at least one machine readable medium of claim 8, the operations further comprising:
identifying an investor in the marketable security;
obtaining an investment parameter for the investor; and
assigning the investor to one of the resource allocation nodes based on the investment parameter.

14. The at least one machine readable medium of claim 13, wherein:
the investment parameter is a maximum investment parameter; and
assigning the investor to one of the resource allocation nodes includes:
generating an investor allocation sub-node for the resource allocation node, the investor allocation sub-node representing a portion of the resources transmitted to the entity assigned to the resource allocation node, the portion being equal to the maximum investment parameter; and
assigning the investor to the investor allocation sub-node.

15. A method for facilitating automatic resource allocation, the method comprising:
obtaining, via a user interface presented on a display device, data representing a resource allocation, the resource allocation having one or more resource-allocation parameters;
generating a resource-allocation-hierarchy data structure that represents a resource allocation hierarchy for the resource allocation, the resource-allocation-hierarchy data structure including a plurality of sub-resource allocation branches based on the resource-allocation parameters;
transmitting, via a computer network, a resource allocation access message to a plurality of entities, the resource allocation access message including a hierarchy identifier for the resource-allocation-hierarchy data structure, the hierarchy identifier providing access by each of the entities in the plurality of entities to the resource-allocation-hierarchy data structure, each of the entities having been provided with security credentials to use when accessing the resource-allocation-hierarchy data structure;
receiving, via the computer network, a set of resource allocation hierarchy requests, each resource allocation hierarchy request (i) corresponding to an entity of the plurality of entities and (ii) including a set of request parameters;
based on a comparison between the resource-allocation parameters of the resource allocation and the request parameters of the resource allocation hierarchy requests, generating at least one resource allocation node for each sub-resource allocation branch, and assigning one or more of the entities in the plurality of entities to each of the resource allocation nodes across the plurality of sub-resource allocation branches;
transmitting resources to each entity that has been assigned to at least one resource allocation node;
automatically generating a marketable security using the data structure; and
presenting the marketable security to an exchange.

16-19. (canceled)

20. The method of claim 15, further comprising:
identifying an investor in the marketable security;
obtaining an investment parameter for the investor; and
assigning the investor to one of the resource allocation nodes based on the investment parameter.

21. The method of claim 20, wherein:
the investment parameter is a maximum investment parameter; and
assigning the investor to one of the resource allocation nodes includes:
generating an investor allocation sub-node for the resource allocation node, the investor allocation sub-node representing a portion of the resources transmitted to the entity assigned to the resource allocation node, the portion being equal to the maximum investment parameter; and
assigning the investor to the investor allocation sub-node.
